(19) United States
(12) Patent Application Publication
(10) Pub. No.: US 2006/0253611 A1
(43) Pub. Date: Nov. 9, 2006

(54) Network address transition methods and systems

(75) Inventors: Chih-Lin Hu, Tainan City (TW); Wei-E Jiang, Shulin City (TW); Wei-Nan Tseng, Taipei City (TW)

Correspondence Address: BIRCH STEWART KOLASCH & BIRCH, PO BOX 747, FALLS CHURCH, VA, 22040-0747, US

(73) Assignee: BENQ CORPORATION, Taoyuan (TW)

(21) Appl. No.: 11/398,558

(22) Filed: Apr. 6, 2006

(30) Foreign Application Priority Data
Apr. 8, 2005 (TW) 94111138

(51) Int. Cl. G06F 15/16

(52) U.S. Cl. 709/245

(57) ABSTRACT

A method for network address transition. A number of electronic apparatuses connecting to a network is detected. It is determined whether a predetermined number exceeds or equals the detected number of electronic apparatuses. If the predetermined number exceeds or equals the detected number, a response function utilized to reply with an address in a specific subnet to a request message from the first electronic device is enabled. The request message is utilized to acquire an address in the subnet.

### BACKGROUND

The present invention relates to network address handling, and more particularly, to network address transition methods and systems.

An increasing amount of digital media on various devices, such as consumer electronics (CEs), mobile devices and personal computers (PCs) are acquired, viewed and managed by users. The vision of the “digital home” combines the Internet, mobile and broadcast networks into a seamless, interoperable network. To realize this vision, the DLNA (Digital Living Network Alliance) has developed a framework for interoperable product design. The DLNA interoperability guidelines are typically used to build interoperable networked platforms and devices for the digital home. Under the guidelines, six functional components have been defined for devices and software infrastructure as well as their technology components: physical media, network transport, media transport, device discovery and control, media management and control, and media formats.

The UPnP Forum has developed a UpnP Device Architecture for pervasive peer-to-peer network connectivity of devices. UPnP technology is recognized under the DLNA interoperability guidelines. Its design provides a distributed, open networking architecture that leverages TCP/IP and Web technologies to enable seamless proximity networking, control and data transfer to ad-hoc or unmanaged networks whether in the home, in a small business, or attached to the Internet. UPnP technology defines a series of communication protocols used for UPnP network addressing, discovery, description, control, eventing and presentation. Two general device classifications are defined by the UPnP architecture: controlled devices and control points.

The foundation for UPnP networking is Internet Protocol (IP) addressing. The IP suite is independent of physical media and capable of tying networked devices together within the home, thereby providing the underlying network communications for applications and enabling connectivity outside the home to the global Internet. Specifically, each DLNA device or UPnP device (which are used interchangeable terms throughout this specification) must have a DHCP client and search for a DHCP server when the device is first connected to the network. If a DHCP server is available, i.e., the network is managed, the device must use the IP address assigned thereto. If no DHCP server is available, i.e., the network is unmanaged; the device must use auto-IP addressing to obtain an address.

When a Dynamic Host Configuration Protocol (DHCP) server has insufficient D-IP addresses to assign, the devices communicate therebetween via A-IP addresses. The devices, however, are unable to communicate with other devices over the Internet via A-IP addresses. Thus, a need exists to provide systems and methods of network address transition to direct devices communicating therebetween via D-IP addresses.

### SUMMARY

Methods for network address transition are provided. A server directs a first electronic device originally using an address in a first subnet as its network address to convert the network address to an address in a second subnet. The server stores a predetermined number of addresses in the second subnet. An embodiment of a network address transition method performed by the server, comprises the following steps. A number of electronic apparatuses connecting to a network is detected. It is determined whether the predetermined number exceeds or equals the detected number of electronic apparatuses. A response function utilized to reply with an address in the second subnet to a request message from the first electronic device is enabled if the predetermined number exceeds or equals the detected number. The request message is utilized to acquire an address in the second subnet.

In the detection step, the number of electronic apparatuses may be determined contingent upon received server discovery messages utilized to detect whether a network address management server is present on the network.

In the detection step, echo requests compatible with the Internet control message protocol (ICMP) may be transmitted to electronic apparatuses employing addresses in a first subnet as their network address, responses corresponding to the echo requests are received, and the number of electronic apparatuses is determined contingent upon the received responses.

An embodiment of a network address transition method may further comprise the following steps. It is determined whether the response function is enabled after receiving a server discovery message utilized to detect whether a network address management server is present on the network. When the response function is enabled, the method replies with a server offer message indicating the network address management server is present on the network.

An embodiment of a network address transition method may further comprise the following steps. Network address renew messages utilized to force acquisition of new addresses in the second subnet are transmitted to the electronic apparatuses if the predetermined number exceeds or equals the detected number.

A machine-readable storage medium storing a computer program which, when executed by the server, performs the method of network address transition is also disclosed.

Servers for network address transition are provided. An embodiment of a server, connecting to multiple electronic devices using addresses in a first subnet as their network address via a network, comprises a storage module, an allocation module, a detection module, a response module and a control module. The storage module stores a predetermined number of addresses in a second subnet. The detection module detects a number of electronic apparatuses connecting to the network. The response module receives and replies to multiple request messages from the electronic apparatuses. The control module determines whether the predetermined number exceeds or equals the detected number, enables the response module, and assigns the addresses stored in the storage module to the electronic apparatuses via the allocation module.

The detection module may determine the number of electronic apparatuses contingent upon received server discovery messages utilized to detect whether a network address management server is present on the network.

The detection module may transmit multiple echo requests compatible with the Internet control message protocol (ICMP) standard to electronic apparatuses using addresses in the second subnet as their network address, receive multiple responses corresponding to the echo requests and determine the number of electronic apparatuses contingent upon the received responses.

One of the electronic apparatuses may transmit a server discovery message utilized to detect whether a network address management server is present on the network. The control module may receive the server discovery message, determine whether the response module is enabled, and, when enabled, direct the response module to reply with a server offer message indicating that the network address management server is present on the network.

The electronic apparatus may receive an address in the second subnet from the server and transmit a network address probe message comprising the received address in the second subnet to the other electronic apparatuses. The network address probe message is utilized to query whether the supplied address conflicts with an address used by any electronic apparatuses. The other electronic apparatuses may receive the network address probe message and transmit the server discovery message. The server may receive the server discovery message, determine whether the response module is enabled, and, when the response module is enabled, reply with a server offer message.

The control module may transmit network address renew messages utilized to force acquisition of new addresses in the first subnet to the electronic apparatuses if the predetermined number exceeds or equals the detected number.

The request message is preferably a DHCPREQUEST message compatible with the dynamic host configuration protocol (DHCP) standard. The server discovery messages are preferably DHCPDISCOVER messages compatible with the DHCP standard. The network address renew message is preferably a DHCPFORCERENEW message compatible with the DHCP standard. The server is preferably a DHCP server.

### DESCRIPTION OF THE DRAWINGS

The invention will become more fully understood by referring to the following detailed description of embodiments with reference to the accompanying drawings, wherein:

FIG. 1 is a diagram of network architecture of an embodiment of a network address transition system;

FIG. 2 is a diagram of a hardware environment applicable to an embodiment of a network address management server or a personal computer;

FIG. 3 is a diagram of a hardware environment applicable to an embodiment of a mobile device;

FIG. 4 is a diagram of system architecture of an embodiment of a Liquid Crystal Display (LCD) apparatus;

FIGS. 5, 6, 7a, 7b, 8a and 8b illustrate flowcharts of methods for network address transition;

FIG. 9 is a diagram of a storage medium storing a computer program for network address transition;

FIG. 10 is a diagram of software modules applicable in an embodiment of a network address management server.

### DETAILED DESCRIPTION

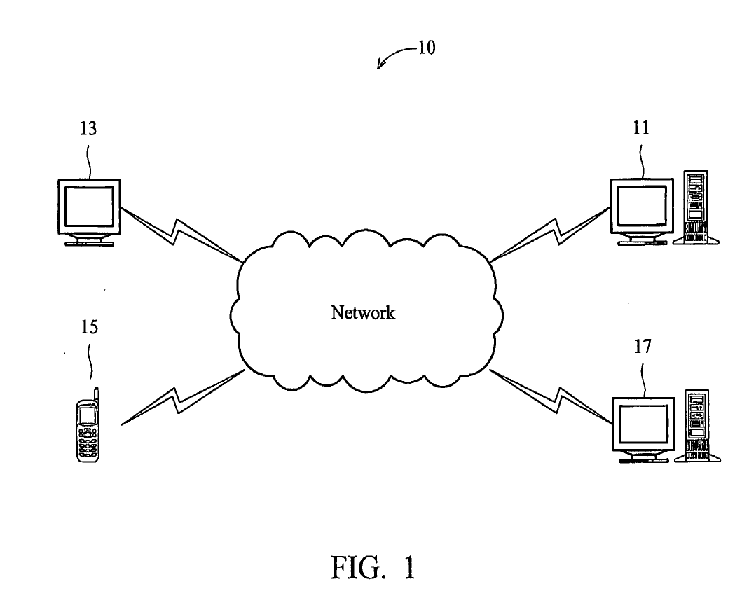

FIG. 1 is a diagram of network architecture of an embodiment of a network address transition system 10, comprising a network address management server 11, display apparatus 13, mobile device 15 and personal computer 17. The display apparatus 13, mobile device 15 and personal computer 17 operate in a network using wired, wireless or a combination thereof to connect to the network address management server 11. The network address management server 11 is preferably a DHCP (Dynamic Host Configuration Protocol) server. Those skilled in the art will recognize that the network address management server 11, display apparatus 13, mobile device 15 and personal computer 17 may be connected in different types of networking environments, and communicate therebetween through various types of transmission devices such as routers, gateways, access points, base station systems or others. The display apparatus 13, mobile device 15 and personal computer 17 are preferably compatible with DLNA (Digital Living Network Alliance) guidelines. The display apparatus 13, mobile device 15 and personal computer 17 may have DHCP clients to search for a DHCP server when they are first connected to the network.

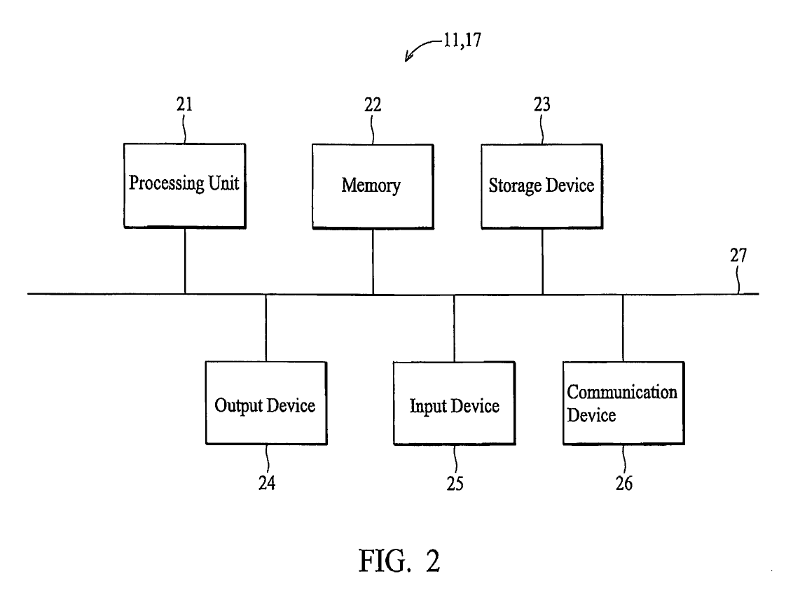

FIG. 2 is a diagram of a hardware environment applicable to an embodiment of the network address management server 11 or personal computer 17, comprising a processing unit 21, memory 22, a storage device 23, an output device 24, an input device 25 and a communication device 26. The processing unit 21 is connected by buses 27 to the memory 22, storage device 23, output device 24, input device 25 and communication device 26 based on Von Neumann architecture. There may be one or more processing units 11, such that the processor of the computer comprises a single central processing unit (CPU), a microprocessing unit (MPU) or multiple processing units, commonly referred to as a parallel processing environment. The memory 22 is preferably a random access memory (RAM), but may also include read-only memory (ROM) or flash ROM. The memory 22 preferably stores program modules executed by the processing unit 21 to perform message compression functions. Generally, program modules include routines, programs, objects, components, or others, that perform particular tasks or implement particular abstract data types. Moreover, those skilled in the art will understand that some embodiments may be practiced with other computer system configurations, including handheld devices, multiprocessor-based, microprocessor-based or programmable consumer electronics, network PCs, minicomputers, mainframe computers, and the like. Some embodiments may also be practiced in distributed computing environments where tasks are performed by remote processing devices linked through a communication network. In a distributed computing environment, program modules may be located in both local and remote memory storage devices based on various remote access architecture such as DCOM, CORBA, Web objects, Web Services or other similar architectures. The storage device 23 may be a hard drive, magnetic drive, optical drive, portable drive, or nonvolatile memory drive. The drives and associated computer-readable media thereof (if required) provide nonvolatile storage of computer-readable instructions, data structures and program modules. The communication device 26 may be a wired network adapter or a wireless network adapter compatible with GPRS, 802.x, Bluetooth and the like.

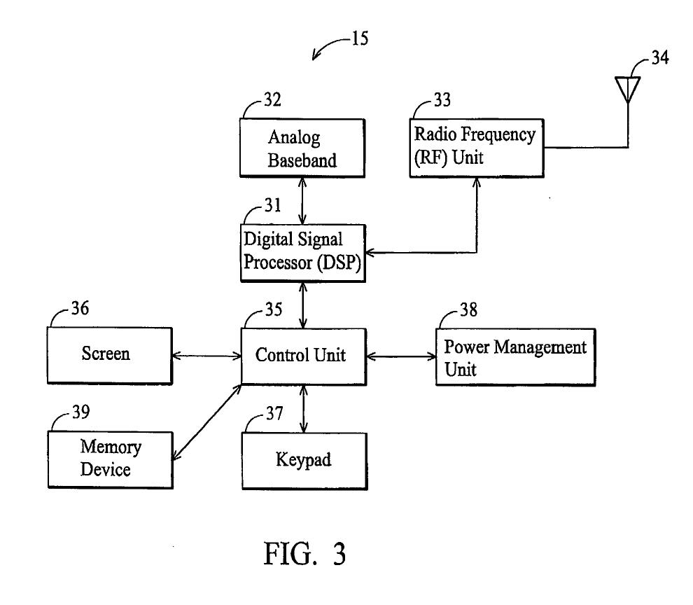

FIG. 3 is a diagram of a hardware environment applicable to an embodiment of the mobile device 15 comprising a digital signal processor (DSP) 31, an analog baseband 32, a radio frequency (RF) unit 33, an antenna 34, a control unit 35, a screen 36, a keypad 37, a power management unit 38 and a memory device 39. Moreover, those skilled in the art will understand that some embodiments may be practiced with other embedded system devices, including digital personal assistant (PDA), digital music player, portable disk drive, programmable consumer electronics, and the like. The memory device 39 is preferably a random access memory (RAM), but may also include read-only memory (ROM) or flash ROM, storing program modules loaded and executed by the control unit 35 to perform network address transition functions.

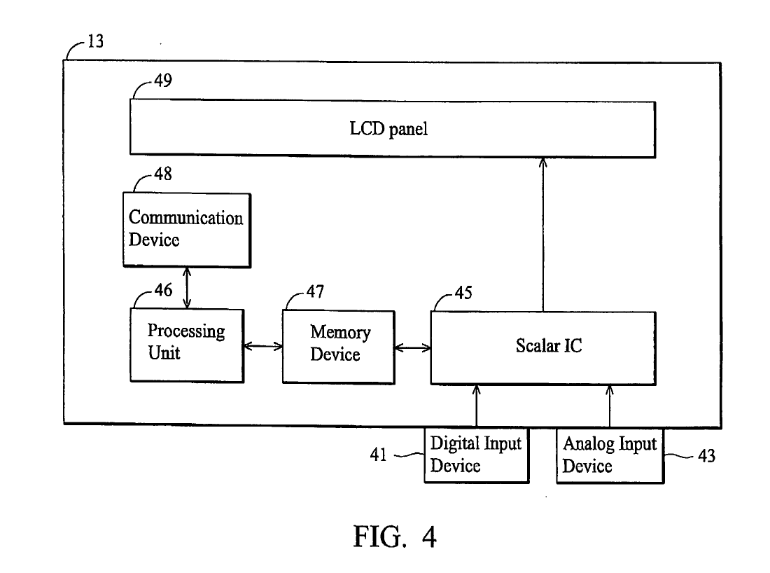

FIG. 4 is a diagram of the system architecture of an embodiment of a liquid crystal display (LCD) apparatus. A LCD apparatus 13 comprises a digital input device 41, an analog input device 43, a scalar IC 45, a processing unit 46, a memory device 47, a communication device 48 and a LCD panel 49. Moreover, those skilled in the art will understand that some embodiments may be practiced with other display configurations, including cathode ray tube (CRT), plasma display panel (PDP), organic light-emitting diode (OLED) displays, and the like. The memory device 47, such as random access memory (RAM), read-only memory (ROM), flash ROM, and the like, stores program modules executed by the processing unit 46 to perform network address transition.

In a DLNA environment, when no DHCP server is available, i.e., the network is unmanaged, or a DHCP server has insufficient addresses to assign, devices may use auto-IP addressing to obtain addresses (i.e. A-IP address) for communication therebetween.

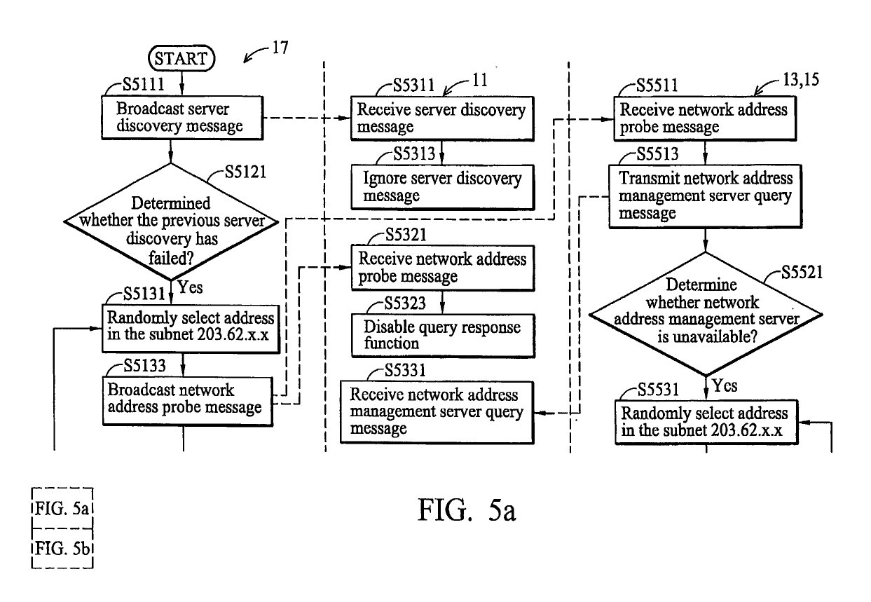

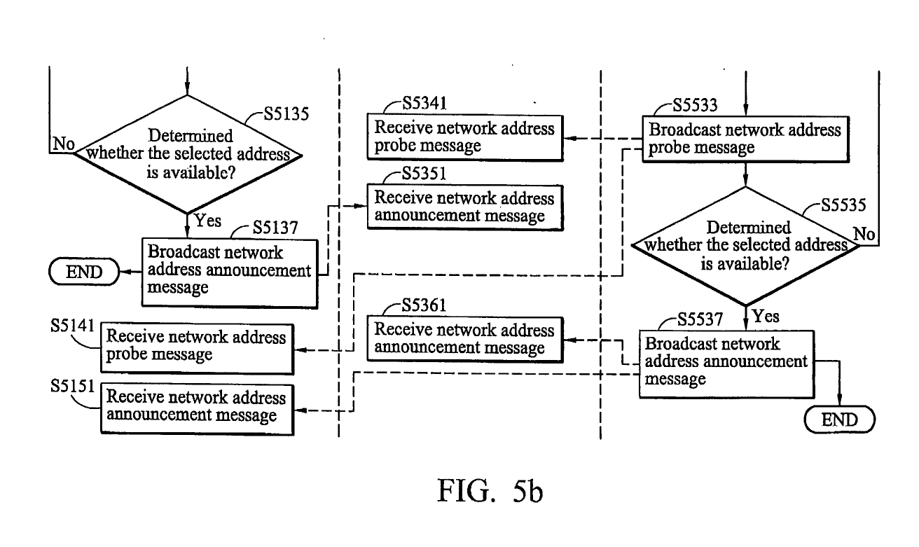

FIG. 5 illustrates a flowchart of an embodiment of a method for network address transition, divided into three sections, a left section showing steps performed by the personal computer 17, a middle section showing steps performed by the network address management server 11, and a right section showing steps performed by the display apparatus 13 or mobile device 15, separated by dashed lines for added clarity. Network addresses in two subnets, such as 192.192.1.x and 203.62.x.x, can be configured as client device addresses. The network address management server 11 assigns stored addresses in the subnet 192.192.1.x to client devices, such as the display apparatus 13, mobile device 15 or personal computer 17, attempting to connect to the network. The display apparatus 13 or mobile device 15 has acquired an address in the subnet 192.192.1.x (i.e. D-address) as its network address. The personal computer 17 initiates a network function to connect to the network and attempts to acquire an available address as its network address.

In step S5111, a server discovery message is broadcast by the personal computer 17 to detect whether a network address management server is present. The server discovery message is preferably a DHCPDISCOVER message compatible with the DHCP standard. The personal computer 17 will ideally receive a server offer message indicating that a network address management server is present on the network. The server offer message is preferably a DHCPOFFER message compatible with the DHCP standard. In step S5311, a server discovery message is received by the network address management server 11. In step S5313, when all stored addresses in the subnet 192.192.1.x have been assigned or cannot be assigned for certain reasons, the received server discovery message is ignored. And alternately, a discovery rejection message is returned to the personal computer 17. The discovery rejection message is preferably a DHCPNAK message compatible with the DHCP standard.

In step S5121, it is determined whether the previous server discovery by the personal computer 17 has failed, and, if so, the process proceeds to step S5131. In this step, if the personal computer 17 does not receive any server offer messages after a time-out expires, it may retransmit the server discovery message (at most a finite number of retransmissions). After one or multiple retransmissions fail to receive any server offer messages, it is determined that the previous server discovery by the personal computer 17 has failed. Alternately, it is determined that the previous server discovery by the personal computer 17 has failed when a discovery rejection message is received.

An automatic address configuration procedure proceeding from steps S5131 to S5137 is performed by the personal computer 17. In step S5131, an address in the subnet 203.62.x.x (i.e. A-address), preferably an Internet Protocol (IP) address, is randomly selected by the personal computer 17. The addresses in the subnet 203.62.x.x are stored in the personal computer 17, display apparatus 13 and mobile device 15 to facilitate execution of the automatic address configuration procedure. In order to provide the connections required by a large number of client devices, the number of stored addresses may be greater than the number of addresses assignable by the network address management server 11. In step S5133, a network address probe message comprising the selected address is broadcast to query whether the supplied address conflicts with an address used by a client device. The network address probe message is preferably an Address Resolution Protocol (ARP) probe message compatible with the ARP standard. The personal computer 17 will ideally not receive a network address conflict message, and otherwise, if the supplied address conflicts with an address used by a client device, the personal computer 17 will receive a network address conflict message. In step S5135, it is determined whether the selected address is available, and, if so, the process proceeds to step S5137, and otherwise, to step S5131. In step S5135, the personal computer 17 receives no network address conflict message after a time-out expires, and determines that the selected address is available. Conversely, the personal computer 17 receives no network address conflict message after a time-out expires, and then retransmits the network address probe message (at most a finite number of retransmissions). After one or multiple retransmissions fail to receive any network address conflict messages, it is determined that the selected address is available by the personal computer 17. In step S5137, a network address announcement message comprising the selected address is broadcast to notify all server and client devices that the supplied address (i.e. A-address) is used to serve as its network address. The network address announcement message is preferably an ARP announcement message compatible with the ARP standard.

In step S5321, the network address probe message is received by the network address management server 11. In step S5323, the query response function is disabled. When the query response function is disabled, network address management server query messages transmitted from any client devices will be ignored (i.e. network address management server acknowledge messages are not sent).

In step S5511, a network address probe message is received by the display apparatus 13 or mobile device 15. In step S5513, a network address management server query message is transmitted to detect whether the network address management server 11 is available. The network address management server query message is preferably a DHCPINFO message compatible with the DHCP standard. The display apparatus 13 or mobile device 15 will ideally receive a network address management server acknowledgement message. If the display apparatus 13 or mobile device 15 does not receive a network address management server acknowledgement message, representing that the network address management server 11 is unavailable. The network address management server acknowledgement message is preferably a DHCPACK message compatible with the DHCP standard. In step S5331, the network address management server query message is received by the network address management server 11. The received query message is ignored (i.e. no network address management server acknowledgement message reply is sent) because the query response function has been previously disabled. In step S5521, it is determined whether the network address management server 11 is unavailable, and, if so, the process proceeds to step S5531. In step S5531, the display apparatus 13 or mobile device 15 receives no network address management server acknowledgement message after a time-out expires, and then determines that the network address management server 11 is unavailable. Conversely, the display apparatus 13 or mobile device 15 receives no network address management server acknowledgement message after a time-out expires, and then retransmits the network address management server query message (at most a finite number of retransmissions). After one or multiple retransmissions fail to receive any network address management server acknowledgement messages by the display apparatus 13 or mobile device 15, it is determined that the network address management server 11 is unavailable.

An automatic address configuration procedure proceeding from steps S5531 to S5537 is performed by the display apparatus 13 or mobile device 15. In step S5531, an address in the subnet 203.62.x.x (i.e. A-address), preferably an Internet Protocol (IP) address, is randomly selected by the display apparatus 13 or mobile device 15. In step S5533, a network address probe message comprising the selected address is broadcast to query whether the supplied address conflicts with an address used by a client device. The display apparatus 13 or mobile device 15 will ideally receive no network address conflict message, and otherwise, if the supplied address conflicts with an address used by a client device, the display apparatus 13 or mobile device 15 will receive a network address conflict message. In step S5535, it is determined whether the selected address is available, and, if so, the process proceeds to step S5537, and otherwise, to step S5531. In step S5535, the display apparatus 13 or mobile device 15 receives no network address conflict message after a time-out expires, and then determines that the selected address is available. Conversely, the display apparatus 13 or mobile device 15 receives no network address conflict message after a time-out expires, and then retransmits the network address probe message (at most a finite number of retransmissions). After one or multiple retransmissions fail to receive any network address conflict messages by the display apparatus 13 or mobile device 15, it is determined that the selected address is available. In step S5537, a network address announcement message comprising the selected address is broadcast to notify all server and client devices that the supplied address (i.e. A-address) is used to serve as its network address.

In step S5311, the network address management server 11 may additionally transmit query messages to client devices using addresses in the subnet 192.192.1.x according to stored information to ensure whether these client devices are still available after receiving a server discovery message. The network address management server 11 reclaims addresses used by client devices that do not reply with acknowledgment of query messages after a predetermined period of time, and subsequently assigns a reclaimed address to the personal computer 17. Conversely, the process proceeds to step S5313 when no assigned address can be reclaimed.

Note that all steps performed in the middle section are omitted when the network address management server 11 is not present in the network or is unavailable.

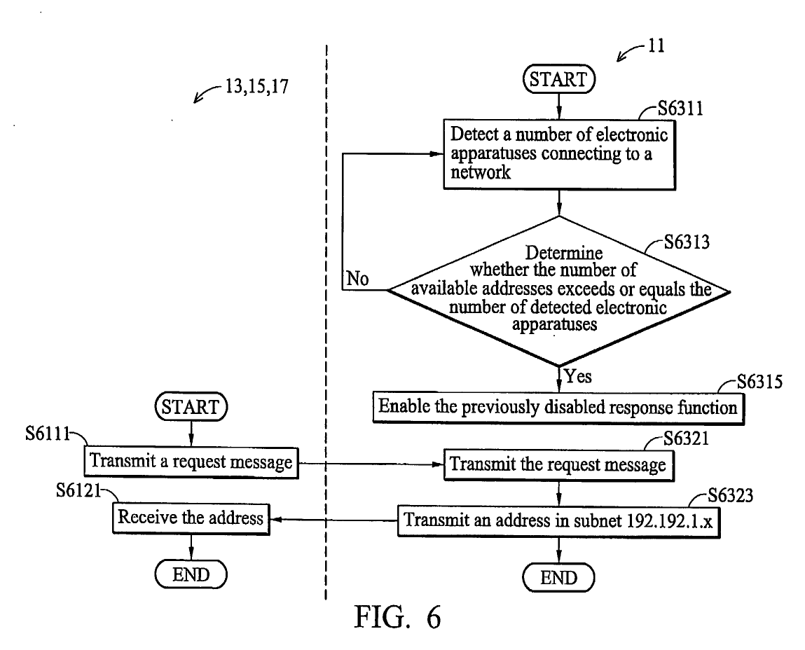

FIG. 6 illustrates a flowchart of an embodiment of a method for network address transition, divided into two sections, a left section showing steps performed by an electronic apparatus, the electronic apparatus may be the personal computer 17, a right section showing steps performed by the network address management server 11, separated by dashed lines for added clarity. Network addresses of two subnets, such as 192.192.1.x and 203.62.x.x, can be configured to be client device addresses. The network address management server 11 assigns an address in the subnet 192.192.1.x to an electronic apparatus. The electronic apparatus has acquired an address in the subnet 203.62.x.x as its network address (i.e. an A-address) using an automatic address configuration procedure.

In step S6311, a number of electronic apparatuses connecting to a network, is detected by the network address management server 11. In step S6313, it is determined whether the number of available addresses in the subnet 192.192.1.x exceeds or equals the number of detected electronic apparatuses, and, if so, the process proceeds to step S6315. In step S6315, enables the previously disabled response function, thereby an electronic apparatus acquires an address in the subnet 192.192.1.x as its network address (i.e. a D-address).

In step S6111, a request message is transmitted by the electronic apparatus. The request message may be periodically transmitted for a period of time, or may be transmitted after receiving a message indicating that the D-addresses are available, for example a DHCPFORCERENEW message compatible with the DHCP standard, from the network address management server 11. In step S6323, an address in the subnet 192.192.1.x is transmitted to the electronic apparatus. In step S6121, the address in the subnet 192.192.1.x is received by the electronic apparatus and replaces the current address (i.e. A-address) with the received address.

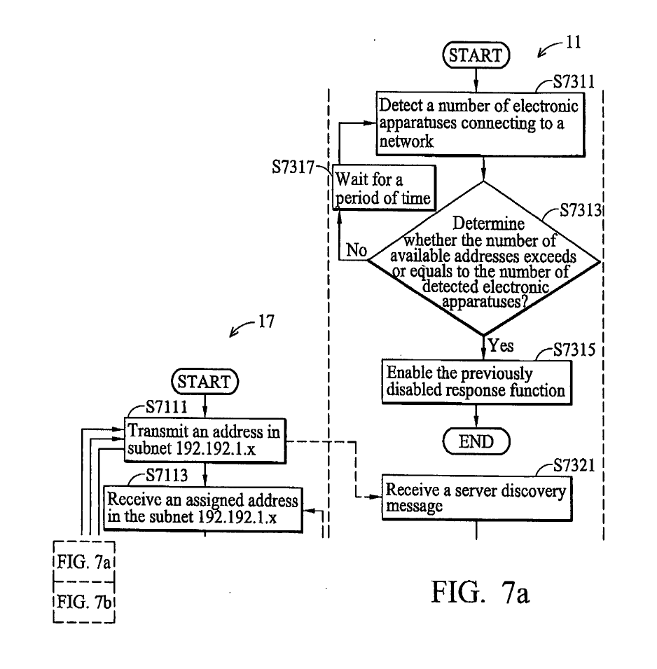

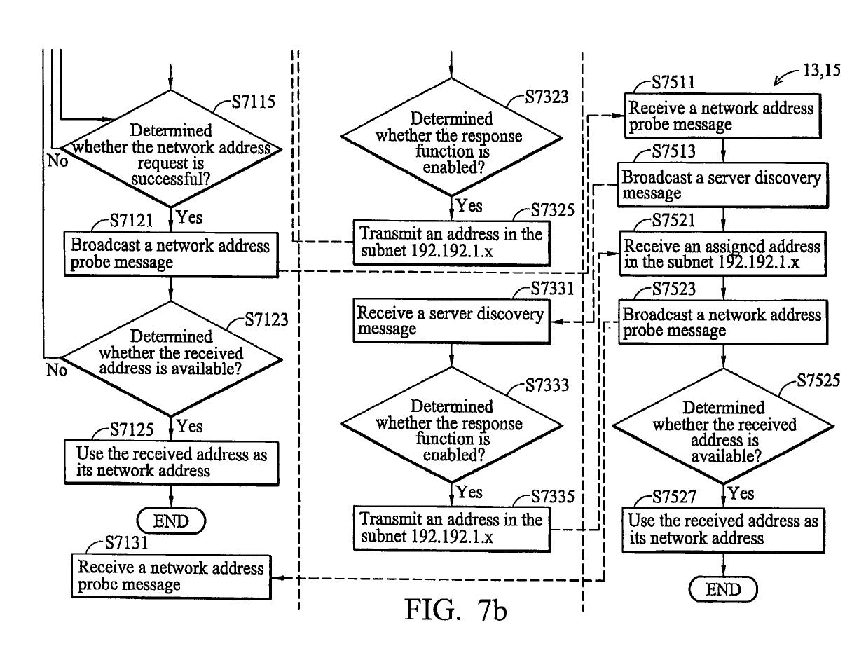

FIGS. 7a and 7b illustrate flowcharts of an embodiment of a method for network address transition, divided into three sections, a left section showing steps performed by the personal computer 17, a middle section showing steps performed by the network address management server 11, and a right section showing steps performed by the display apparatus 13 or mobile device 15, separated by dashed lines for added clarity. Network addresses of two subnets, such as 192.192.1.x and 203.62.x.x, can be configured to be client device addresses. The network address management server 11 assigns an address of 192.192.1.x to an electronic apparatus, such as the display apparatus 13, mobile device 15 or personal computer 17, to be its network address (D-address). The electronic apparatuses have respectively acquired addresses of 203.62.x.x as their network addresses (i.e. A-addresses) using automatic address configuration procedures.

In step S7311, a number of electronic apparatuses connecting to a network, is detected by the network address management server 11. The number of electronic apparatuses connecting to a network may be detected by calculation of received server discovery messages. The server discovery message is utilized to detect whether a network address management server is present on the network. The server discovery message is preferably a DHCPDISCOVER message compatible with the DHCP standard. The network address management server 11 may transmit echo requests compatible with the Internet control message protocol (ICMP) to electronic apparatuses using A-addresses as their network addresses, and determines a number of electronic apparatuses connecting to the network contingent upon corresponding responses. In step S7313, it is determined whether the number of available addresses in the subnet 192.192.1.x exceeds or equals to the number of detected electronic apparatuses, and, if so, the process proceeds to step S7315, and otherwise, to step S7317. In step S7315, the previously disabled response function is enabled, thereby an electronic apparatus acquires an address in the subnet 192.192.1.x as its network address (i.e. a D-address). Step S7317 is an idle period prior to step S7311.

In step S7111, a server discovery message is broadcast by the personal computer 17 to detect whether a network address management server is present. The server discovery message is preferably a DHCPDISCOVER message compatible with the DHCP standard. The server discovery message is typically broadcast when the personal computer 17 connects to the network or after a predetermined period of time, for example, five minutes. In step S7321, a server discovery message is received by the network address management server 11. In step S7323, it is determined whether the response function is enabled, and, if so, the process proceeds to step S7325. In step S7325, an address in the subnet 192.192.1.x is assigned and transmitted to the personal computer 17. The network address management server 11 may first send a DHCPOFFER message compatible with the DHCP standard to reply to the DHCPDICSOVER message, and subsequently sends a DHCPACK message compatible with the DHCP standard, which comprises an assigned address in the subnet 192.192.1.x, to reply to a DHCPREQUEST message compatible with the DHCP standard.

In step S7113, an assigned address in the subnet 192.192.1.x is received by the personal computer 17. In step S7115, it is determined whether the network address request is successful, and, if so, the process proceeds to step S7121, and otherwise, to step S7111. In step S7115, the personal computer 17 determines the network address request is successful when an assigned address is received. Conversely, the personal computer 17 receives no assigned address after a time-out expires, and then retransmits the server discovery message (at most a finite number of retransmissions). After one or multiple retransmissions fail to receive any assigned address, it is determined that the network address request has failed. In step S7121, a network address probe message comprising the received address (D-address) is broadcast to query whether the supplied address conflicts with an address used by a client device. The network address probe message is preferably an Address Resolution Protocol (ARP) probe message compatible with the ARP standard. Ideally, the personal computer 17 will not receive a network address conflict message, and otherwise, if the supplied address conflicts with an address used by a client device, the personal computer 17 will receive a network address conflict message. In step S7123, it is determined whether the received address is available, and, if so, the process proceeds to step S7125, and otherwise, to step S7111. In step S7125, the originally configured A-address is replaced with the received D-address as its network address.

In step S7511, a network address probe message is received by the display apparatus 13 or mobile device 15. The process proceeds to step S7513 because the received network address probe message comprises a D-address. In step S7513, a server discovery message is broadcast by the display apparatus 13 or mobile device 15 to detect whether a network address management server is present. The server discovery message is preferably a DHCPDISCOVER message compatible with the DHCP standard. In step S7331, a server discovery message is received by the network address management server 11. In step S7333, it is determined whether the response function is enabled, and, if so, the process proceeds to step S7335. In step S7335, an address in the subnet 192.192.1.x is assigned and transmitted to the personal computer 17. The network address management server 11 may first send a DHCPOFFER message compatible with the DHCP standard to reply to the DHCPDICSOVER message, and subsequently sends a DHCPACK message compatible with the DHCP standard, which comprises an assigned address in the subnet 192.192.1.x, to reply to a DHCPREQUEST message compatible with the DHCP standard.

In step S7321, a network address offer message comprising an assigned address in the subnet 192.192.1.x is received by the display apparatus 13 or mobile device 15. In step S7323, a network address probe message comprising the received address (D-address) is broadcast to query whether the supplied address conflicts with an address used by a client device. The network address probe message is preferably an ARP probe message compatible with the ARP standard. The display apparatus 13 or mobile device 15 will ideally not receive a network address conflict message, and otherwise, if the supplied address conflicts with an address used by a client device, the display apparatus 13 or mobile device 15 will receive a network address conflict message. The network address conflict message is preferably a DHCPDECLINE message compatible with the DHCP standard. In step S7325, it is determined whether the received address is available, if so, the process proceeds to step S7327. In step S7327, the originally configured A-address is replaced with the received D-address as its network address.

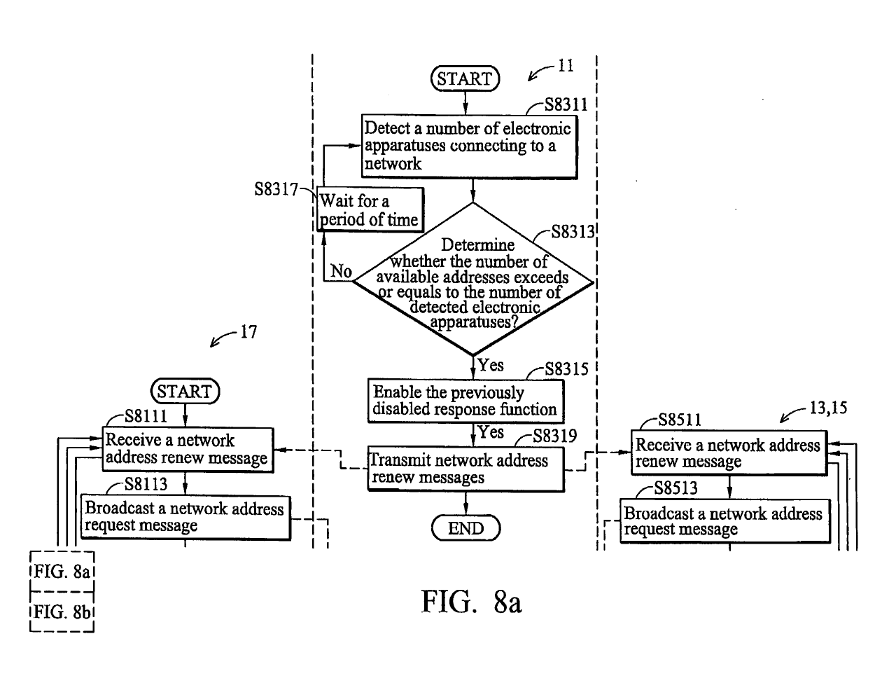

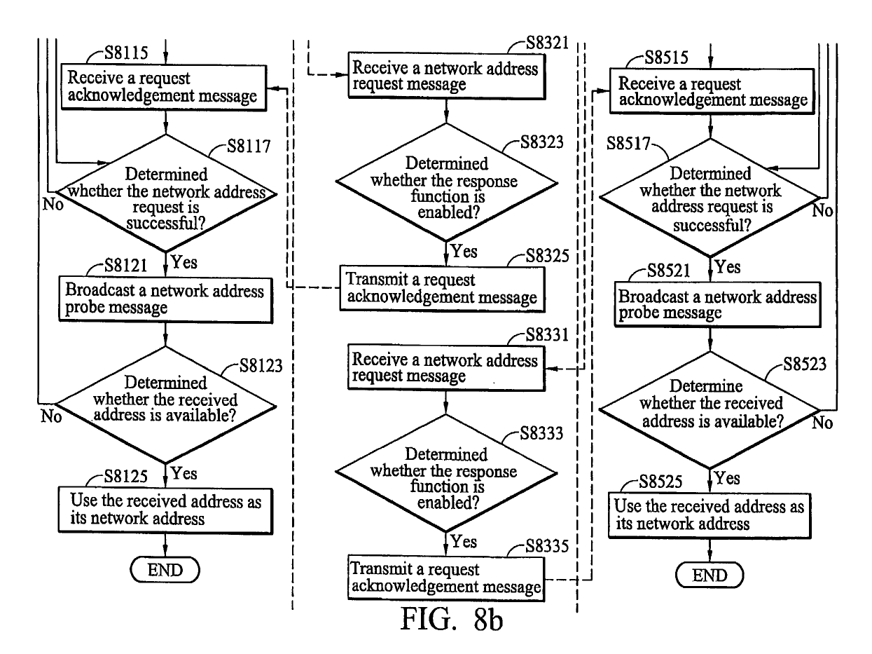

FIGS. 8a and 8b illustrate flowcharts of an embodiment of a method for network address transition, divided into three sections, a left section showing steps performed by the personal computer 17, a middle section showing steps performed by the network address management server 11, and a right section showing steps performed by the display apparatus 13 or mobile device 15, separated by dashed lines for added clarity. Network addresses of two subnets, such as 192.192.1.x and 203.62.x.x, can be configured to be client device addresses. The network address management server 11 assigns an address in 192.192.1.x to an electronic apparatus, such as the display apparatus 13, mobile device 15 or personal computer 17, to be its network address (D-address). The electronic apparatuses have respectively acquired addresses in 203.62.x.x as their network addresses (i.e. A-addresses) using automatic address configuration procedures.

In step S8311, a number of electronic apparatuses connecting to a network, is detected by the network address management server 11. The number of electronic apparatuses connecting to a network may be detected by calculation of received server discovery messages. The server discovery message is utilized to detect whether a network address management server is present on the network. The server discovery message is preferably a DHCPDISCOVER message compatible with the DHCP standard. The network address management server 11 may transmit echo requests compatible with the ICMP to electronic apparatuses using A-addresses as their network addresses, and determines a number of electronic apparatuses connecting to the network contingent upon corresponding responses. In step S8313, it is determined whether the number of available addresses in the subnet 192.192.1.x exceeds or equals the number of detected electronic apparatuses, and, if so, the process proceeds to step S8315, and otherwise, to step S8317. Step S8315 enables the previously disabled response function, thereby an electronic apparatus to acquire an address in the subnet 192.192.1.x to be its network address (i.e. a D-address). Step S8317 is a idle period prior to step S8311. In step S8319, network address renew messages are transmitted to the personal computer 17, display apparatus 13 and mobile device 15. The network address renew messages are utilized to force the personal computer 17, display apparatus 13 and mobile device 15 to acquire new addresses in the subnet 192.192.1.x, preferably DHCPFORCERENEW messages compatible with the DHCP standard.

In step S8111, a network address renew message is received by the personal computer 17. In step S8113, a network address request message is broadcast to the network address management server 11 to acquire a new address in the subnet 192.192.1.x (i.e. D-address). The network address request message is preferably a DHCPREQUEST message compatible with the DHCP standard. In step S8321, a network address request message is received by the network address management server 11. The network address request message is preferably a DHCPREQUEST message compatible with the DHCP standard. In step S8323, it is determined whether the response function is enabled, and, if so, the process proceeds to step S8325. In step S8325, a request acknowledgement message comprising an assigned address in the subnet 192.192.1.x is transmitted to the personal computer 17. The request acknowledgement message is preferably a DHCPACK message compatible with the DHCP standard.

In step S8115, a request acknowledgement message comprising an assigned address in the subnet 192.192.1.x is received by the personal computer 17. In step S8117, it is determined whether the network address request is successful, and, if so, the process proceeds to step S8121, and otherwise, to step S8113. In step S8117, the personal computer 17 determines the network address request is successful when an assigned address is received. Conversely, the personal computer 17 receives no assigned address after a time-out expires, and then retransmits the network address request message (at most a finite number of retransmissions). After one or multiple retransmissions fail to receive any assigned address, it is determined that the network address request has failed. In step S8121, a network address probe message comprising the received address (D-address) is broadcast to query whether the supplied address conflicts with an address used by a client device. The network address probe message is preferably an ARP probe message compatible with the ARP standard. The personal computer 17 will ideally not receive a network address conflict message, and otherwise, if the supplied address conflicts with an address used by a client device, the personal computer 17 will receive a network address conflict message. In step S8123, it is determined whether the received address is available, and, if so, the process proceeds to step S8125, and otherwise, to step S8113. In step S8125, the originally configured A-address is replaced with the received D-address as its network address.

In step S8511, a network address renew message is received by the display apparatus 13 or mobile device 15. In step S8513, a network address request message is broadcast to the network address management server 11 to acquire a new address in the subnet 192.192.1.x (i.e. D-address). The network address request message is preferably a DHCPREQUEST message compatible with the DHCP standard. In step S8331, a network address request message is received by the network address management server 11. The network address request message is preferably a DHCPREQUEST message compatible with the DHCP standard. In step S8333, it is determined whether the response function is enabled, and, if so, the process proceeds to step S8335. In step S8335, a request acknowledgement message comprising an assigned address in the subnet 192.192.1.x is transmitted to the display apparatus 13 or mobile device 15. The request acknowledgement message is preferably a DHCPACK message compatible with the DHCP standard.

In step S8515, a request acknowledgement message comprising an assigned address in the subnet 192.192.1.x is received by the display apparatus 13 or mobile device 15. In step S8517, it is determined whether the network address request is successful, and, if so, the process proceeds to step S8521, and otherwise, to step S8513. In step S8517, the display apparatus 13 or mobile device 15 determines the network address request is successful when an assigned address is received. Conversely, the display apparatus 13 or mobile device 15 receives no assigned address after a time-out expires, and then retransmits the network address request message (at most a finite number of retransmissions). After one or multiple retransmissions fail to receive any assigned address, it is determined that the network address request has failed. In step S8521, a network address probe message comprising the received address (D-address) is broadcast to query whether the supplied address conflicts with an address used by a client device. The network address probe message is preferably an ARP probe message compatible with the ARP standard. The display apparatus 13 or mobile device 15 will ideally not receive a network address conflict message, and otherwise, if the supplied address conflicts with an address used by a client device, the display apparatus 13 or mobile device 15 will receive a network address conflict message. In step S8523, it is determined whether the received address is available, and, if so, the process proceeds to step S8125, and otherwise, to step S8513. In step S8525, the originally configured A-address is replaced with the received D-address as its network address.

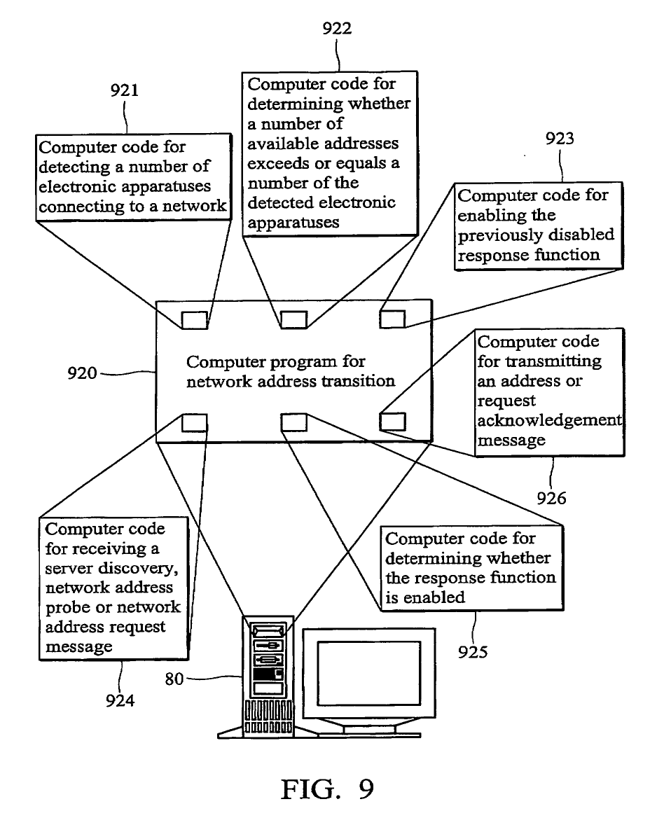

Also disclosed is a storage medium as shown in FIG. 9 storing a computer program 920 providing the disclosed methods of network address transition. The computer program includes a storage medium 90 having computer readable program code therein for use in a computer system. The computer readable program code comprises at least computer readable program code 921 detecting a number of electronic apparatuses connecting to a network, computer readable program code 922 determining whether a number of available addresses exceeds or equals a number of the detected electronic apparatuses, computer readable program code 923 enabling the previously disabled response function, computer readable program code 924 receiving a server discovery, network address probe or network address request message, computer readable program code 925 determining whether the response function is enabled, and computer readable program code 926 transmitting an address or request acknowledgement message.

Systems and methods, or certain aspects or portions thereof, may take the form of program code (i.e., instructions) embodied in tangible media, such as floppy diskettes, CD-ROMS, hard drives, or any other machine-readable storage medium, wherein, when the program code is loaded into and executed by a machine, such as a computer system, MS, PDA, MSC, SMSC and the like, the machine becomes an apparatus for practicing the invention. The disclosed methods and apparatuses may also be embodied in the form of program code transmitted over some transmission medium, such as electrical wiring or cabling, through fiber optics, or via any other form of transmission, wherein, when the program code is received and loaded into and executed by a machine, such as a computer or an optical storage device, the machine becomes an apparatus for practicing the invention. When implemented on a general-purpose processor, the program code combines with the processor to provide a unique apparatus that operates analogously to specific logic circuits.

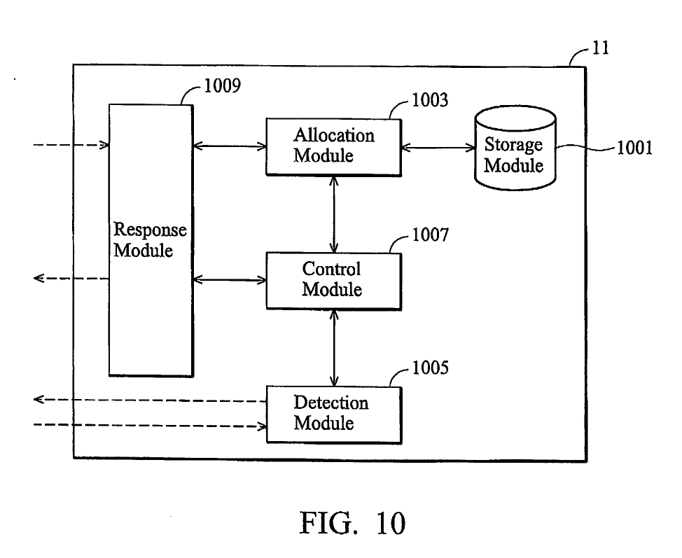

FIG. 10 is a diagram of software modules applicable in an embodiment of a network address management server 11. The network address in two subnets, such as 192.192.1.x and 203.62.x.x, can be configured to be client device addresses. The network address management server 11 assigns an address of 192.192.1.x to an electronic apparatus, such as the display apparatus 13, mobile device 15 or personal computer 17, as its network address (D-address). The electronic apparatuses have respectively acquired addresses of 203.62.x.x as their network addresses (i.e. A-addresses) using automatic address configuration procedures.

The network address management server 11 comprises a storage module 1001, an allocation module 1003, a detection module 1005, a control module 1007 and a response module 1009. The storage module 1001 stores a predetermined number of addresses in the subnet 192.192.1.x. The detection module 1005 detects a number of electronic apparatuses connecting to a network. The response module 1009 receives and replies to multiple request messages from the electronic apparatuses. The control module 1007 determines the predetermined number exceeding or equaling the detected number, enables the response module 1009, and assigns the addresses stored in the storage module 1001 to the electronic apparatuses via the allocation module 1003. The request message is preferably a DHCPREQUEST message compatible with the DHCP standard.

The detection module 1005 may determine the number of electronic apparatuses contingent upon received server discovery messages utilized to detect whether a network address management server is present on the network. The server discovery messages are preferably DHCPDISCOVER messages compatible with the DHCP standard.

The detection module 1005 may transmit multiple echo requests compatible with the ICMP standard to electronic apparatuses using addresses in the subnet 203.62.x.x as their network addresses, receive multiple responses corresponding to the echo requests and determine the number of electronic apparatuses contingent upon the received responses.

One of the electronic apparatuses may transmit a server discovery message utilized to detect whether a network address management server is present on the network. The control module 1007 may receive the server discovery message, determine whether the response module is enabled, and, when the response module is enabled, direct the response module to reply with a server offer message utilized to notify that the network address management server is present on the network.

The electronic apparatus may receive an address in the second subnet from the network address management server 11 and transmit a network address probe message comprising the received address in the second subnet to the other electronic apparatuses. The network address probe message is utilized to query whether the supplied address conflicts with an address used by any of the electronic apparatuses. The other electronic apparatuses may receive the network address probe message and transmit the server discovery message. The network address management server 11 may receive the server discovery message, determine whether the response module is enabled, and, when the response module is enabled, reply with a server offer message. The network address probe message is preferably an ARP Probe message compatible with the ARP standard.

The control module 1007 may transmit network address renew messages utilized to force acquisition of new addresses in the subnet 192.192.1.x to the electronic apparatuses if the predetermined number exceeds or equals the detected number. The network address renew messages are preferably DHCPFORCERENEW messages compatible with the DHCP standard.

While the invention has been described in terms of preferred embodiment, it is not intended to limit the invention to the precise embodiments disclosed herein. Those who are skilled in this technology can still make various alterations and modifications without departing from the scope and spirit of this invention. Therefore, the scope of the invention shall be defined and protected by the following claims and their equivalents.

What is claimed is:

1. A method of network address transition, performed by a server directing a first electronic device originally using an address in a first subnet as its network address to convert the network address to an address in a second subnet, the server storing a predetermined number of addresses in the second subnet, the method comprising:
detecting a number of electronic apparatuses connecting to a network;
determining whether the predetermined number exceeds or equals the detected number of electronic apparatuses; and
if the predetermined number exceeds or equals the detected number, enabling a response function utilized to reply with an address in the second subnet to a request message from the first electronic device,
wherein the request message is utilized to acquire an address in the second subnet.

2. The method as claimed in claim 1 wherein the request message is a DHCPREQUEST message compatible with the dynamic host configuration protocol (DHCP) standard.

3. The method as claimed in claim 1 wherein the detection step comprises determining the number of electronic apparatuses contingent upon a plurality of received server discovery messages utilized to detect whether a network address management server is present on the network.

4. The method as claimed in claim 3 wherein the server discovery messages are DHCPDISCOVER messages compatible with the dynamic host configuration protocol (DHCP) standard.

5. The method as claimed in claim 1 wherein the detection step comprises:
transmitting a plurality of echo requests compatible with the Internet control message protocol (ICMP) to electronic apparatuses using addresses in a first subnet as its network address;
receiving a plurality of responses corresponding to the echo requests; and
determining the number of electronic apparatuses contingent upon the received responses.

6. The method as claimed in claim 1 further comprising:
determining whether the response function is enabled after receiving a server discovery message utilized to detect whether a network address management server is present on the network; and
replying with a server offer message indicating that the network address management server is present on the network when the response function is enabled.

7. The method as claimed in claim 1 further comprising if the predetermined number exceeds or equals the detected number, transmitting a plurality of network address renew messages utilized to force acquisition of a new addresses in the second subnet to the electronic apparatuses.

8. The method as claimed in claim 7 wherein the network address renew message is a DHCPFORCERENEW message compatible with the dynamic host configuration protocol (DHCP) standard.

9. The method as claimed in claim 1 wherein the server is a dynamic host configuration protocol (DHCP) server.

10. A machine-readable storage medium for storing a computer program which, when executed by a server, performs a method of network address transition, the server directing a first electronic device originally using an address of a first subnet as its network address to convert the network address to an address of a second subnet, the method comprising:
detecting a number of electronic apparatuses connecting to a network;
determining whether the predetermined number exceeds or equals the detected number of electronic apparatuses; and
if the predetermined number exceeds or equals the detected number, enabling a response function utilized to reply with an address in the second subnet to a request message from the first electronic device,
wherein the request message is utilized to acquire an address in the second subnet.

11. A server connecting to a plurality of electronic devices via a network, the electronic devices using addresses in a first subnet as their network address, the server comprising:
a storage module storing a predetermined number of addresses in a second subnet;
an allocation module;
a detection module detecting a number of electronic apparatuses connecting to the network;
a response module replying to a plurality of request messages from the electronic apparatuses; and
a control module determining the predetermined number exceeding or equaling the detected number, enabling the response module and assigning the addresses stored in the storage module to the electronic apparatuses via the allocation module.

12. The server as claimed in claim 11 wherein the request message is a DHCPREQUEST message compatible with the dynamic host configuration protocol (DHCP) standard.

13. The server as claimed in claim 11 wherein the detection module determines the number of electronic apparatuses contingent upon a plurality of received server discovery messages utilized to detect whether a network address management server is present on the network.

14. The server as claimed in claim 13 wherein the server discovery messages are DHCPDISCOVER messages compatible with the dynamic host configuration protocol (DHCP) standard.

15. The server as claimed in claim 11 wherein the detection module transmits a plurality of echo requests compatible with the Internet control message protocol (ICMP) standard to electronic apparatuses using addresses in a first subnet as their network address, receives a plurality of responses corresponding to the echo requests and determines the number of electronic apparatuses contingent upon the received responses.

16. The server as claimed in claim 11 wherein one of the electronic apparatuses transmits a server discovery message utilized to detect whether a network address management server is present on the network, and the control module receives the server discovery message, determines whether the response module is enabled, and, when the response module is enabled, directs the response module to reply with a server offer message utilized to notify that the network address management server is present on the network.

17. The server as claimed in claim 16 wherein the electronic apparatus receives an address in the second subnet from the server and transmits a network address probe message comprising the received address in the second subnet to the other electronic apparatuses, the network address probe message is utilized to query whether the supplied address conflicts with an address used by any electronic apparatuses, the other electronic apparatuses receive the network address probe message and transmit the server discovery message, and the server receives the server discovery message, determines whether the response module is enabled, and, when the response module is enabled, replies with the server offer message.

18. The server as claimed in claim 17 wherein the network address probe message is an address resolution protocol (ARP) Probe message compatible with the ARP standard.

19. The server as claimed in claim 11 wherein the control module transmits a plurality of network address renew messages utilized to force acquisition of new addresses in the second subnet to the electronic apparatuses if the predetermined number exceeds or equals the detected number.

20. The server as claimed in claim 19 wherein the network address renew messages are DHCPFORCERENEW messages compatible with the dynamic host configuration protocol (DHCP) standard.
